(19) United States
(12) Patent Application Publication
(10) Pub. No.: US 2004/0237791 A1
(43) Pub. Date: Dec. 2, 2004

(54) Air purifier

(76) Inventor: Se Kit Yuen, Hong Kong (HK)

Correspondence Address: Dr. Arthur King Ma, 1030 Coronado Drive, Arcadia, CA, 91007, US

(21) Appl. No.: 10/672,765

(22) Filed: Sep. 25, 2003

(30) Foreign Application Priority Data
May 30, 2003 (CN) 03140563.0

(51) Int. Cl. B01D 46/00

(52) U.S. Cl. 96/224

(57) ABSTRACT

An air purifier employs photoelectrons to eliminate germs, viruses, funguses and airborne microorganisms or particles in the air comprising a three-dimensional housing 1, an exhaust frame grid 2 at front end of said housing 1, and a rear end of a panel 3. Ionized air is emitted from said exhaust frame grid 2. When said air full of germs, viruses, funguses and other harmful airborne microorganisms or particles in the air moved into an air aggregation wall 26 through said air aggregator 25, and then into said air inlet 7, which is between said ultraviolet radiation tube 21 and said air aggregation wall 26. When said air full of germs, viruses, funguses and other harmful airborne microorganisms or particles in the air, said ultraviolet radiation tube 21 generates extreme ultraviolet to eliminate said germs, viruses, funguses and other harmful airborne microorganisms or particles in the air. Then purified air is emitted to said exhaust frame grid 2, to further ionized and purified through said high negative voltage carbonated fiber 12. From said exhaust frame grid 2, fresh air filled with anions is emitted to improve the room air.

### BACKGROUND OF THE PRESENT INVENTION

1. Field of the Present Invention

This present invention relates to an air purifier and more particularly to an air purifier with photoelectrons and ultraviolet ray that increase the quantity of anions to eliminate germs, viruses, funguses and other harmful airborne microorganisms or particles in the air.

2. Description of Related Arts

Numerous air filters have been provided in prior art. For example, U.S. Pat. No. 3,967,927, U.S. Pat. No. 4,210,429; U.S. Pat. No. 5,171,060 and U.S. Pat. No. 5,330,722 all are illustrative of such prior art. While these units may be suitable for the particular purpose to which they address, they would not be as suitable for the purposes of the present invention as heretofore described.

As disclosed in U.S. Pat. No. 3,967,927, an ultraviolet lamp fixture for purifying the air within a room by means of passing the air over a plurality of hot cathode or other commercially available ultraviolet ray tubes. The tubes are mounted vertically within a decoratively covered, easily movable, pole-mounted housing having a motorized fan, which moves air through an opening in the lower portion of the housing over the tubes for purification. The purified air stream is exhausted through the top portion of the housing and returned to the room. The interior of the housing has deflector vanes which function to create a turbulent airflow in the area of the tubes to insure that contacting the lamps purifies all of the air passing through the lamp fixture. The lamp fixture is provided with means for filtering the circulating air. In an alternate embodiment, the air passes through a dehumidifier prior to passing by the tubes.

Furthermore, U.S. Pat. No. 4,210,429, a room air purifier for quietly removing irritating or harmful impurities from the air circulating within the room. The purifier removes from room air, particles down to 0.3 microns in size with 99.9% efficiency. The air purifier comprises a somewhat elongated upright housing having an easily-removable back, a two-speed blower that is preferably AC operated and disposed at the bottom of the housing, a pair of vertically disposed ultraviolet lamps and associated means for powering the lamps including push button switch means, and preferably three separate filters including a pre-filter disposed at the inlet of the blower, a highly efficient main filter element vertically stacked over the blower and lamps and a charcoal filter disposed over the main filter element. The blower sucks the air in the bottom of the purifier through the pre-filter and up adjacent to the lamps to the main filter element and charcoal filter, and from there the purified air passes to a top baffle cover where the air is exited in preferably four directions from the purifier.

In U.S. Pat. No. 5,171,060, an ornament-displaying article of furniture having a weight-bearing surface member and pedestal base has a supporting substantially cylindrical and preferably transparent column releasable connected to the weight-bearing surface member. The appearance of the column may be altered with an agglomeration or reflective fill material, such as marbles, which may be exchanged by detaching the column from the weight-bearing surface member in a preferred embodiment a light source irradiates light reflective or light radiant material of the fill.

In U.S. Pat. No. 5,330,722 a germicidal air purifier for trapping and destroying airborne microorganisms is disclosed. The air purifier includes an ultraviolet radiation source and a juxtaposed filter medium. One ultraviolet radiation source and filter medium is fixed and the other is displaceable, so that at least an upstream side of the filter medium is systematically exposed to germicidal levels of radiation. In a first preferred embodiment, a fixed ultraviolet lamp irradiates a cylindrical air filter, which is rotated on its longitudinal axis in close proximity to the lamp, so that the upstream side of the filter is systematically irradiated. In a second preferred embodiment, a radiant lamp fixture is moved reciprocally across an upstream side of a planar filter, to systematically irradiate the filter. In a third preferred embodiment, a radiant lamp fixture is rotated about an axis, which is orthogonal to its longitudinal midpoint, so that a circular area of a planar filter is irradiated. The advantage is that microorganisms trapped on the filters are exposed to a lethal dose of radiation and the air purifier is consistently effective at destroying a significant percentage of airborne microorganisms suspended in the air passed through the filter.

### SUMMARY OF THE PRESENT INVENTION

A main object of the present invention is to provide an air filter with photoelectrons and ultraviolet ray that increase the quantity of anions to eliminate germs, viruses, funguses and other harmful airborne microorganisms or particles in the air.

Another object of the present invention is to provide an ion air purifier that can eliminate germs, viruses, funguses and other harmful airborne microorganisms or particles in the air.

Accordingly, in order to accomplish the above objects, the present invention provides an air purifier, comprising:

a three-dimensional housing for actuating an assemblage having a plurality of air inlets and a plurality of air outlets with predetermined sharp, wherein the three-dimensional housing comprises:

at least one extractor fan mean horizontally inserted and engaged in said three-dimensional housing for mean of drawing air into said three-dimensional housing through said air inlet, through a ultraviolet radiation tube mean and out of said housing through said air outlet,

an air aggregator integrally provided between said extractor fan mean and said housing,

a ultraviolet radiation tube mean for generating ultraviolet rays to produce and increase the quantity of anions is integrally connected within said housing, said air inlet and air outlet are connected at both ends of said a ultraviolet radiation tube mean,

an electric circuit with a voltage transformer connected with an indicator light, a starter electrically connected via said electric circuit to said ultraviolet radiation tube,

a switch on said housing electrically connected via said electric circuit between said housing and said air drawing means, and a plug on an electric cord electrically connected to said electric circuit and a power generator to engage with a wall socket to receive electricity therefrom;

a high negative voltage discharge/carbonated fiber is connected between said ultraviolet radiation tube and said air outlet.

When air enters into said air purifier via said extractor fan, said air purifier works in two alternate modes in loop. A first mode is to output high negative voltage intermittently (about 3 to 4 minutes between each interception) via said carbonated fiber discharge; anions are produced then said extractor fan blows said anions out of said three-dimensional housing through said air outlet. Second mode is to ignite said ultraviolet radiation tube intermittently (about 7 to 10 minutes between each interception) to eliminate germs, viruses, funguses and other harmful airborne microorganisms or particles in the air.

Said high negative voltage fiber is fixed on said air outlet, said ultraviolet radiation tube mean for generating ultraviolet rays, said ultraviolet radiation tube mean producing and increasing the quantity of anions is integrally connected within said housing, said air inlet and air outlet are connected at both ends of said a ultraviolet radiation tube mean. When air filled with germs, viruses, funguses other harmful airborne microorganisms or particles in the air enters said three-dimensional housing via said air inlet, it travels through the photoelectrons frame grid where said germs, viruses, funguses and other harmful airborne microorganisms or particles are killed, and reaches said outlet. During this process, said air goes through said ultraviolet radiation tube mean and said ultraviolet radiation tube mean destroys said germs, viruses, funguses and other harmful airborne microorganisms or particles in the air by ultraviolet radiation, while said ultraviolet radiation tube mean to produce and increase the quantity of anions. When said air passes through said ultraviolet radiation tube mean, said air then filled with anions for purification. Fresh air full of anions is then emitted via said air outlet. Thus the air quality in the room is improved.

### BRIEF DESCRIPTION OF THE DRAWINGS

FIG. 1 is the perspective view of the present invention.

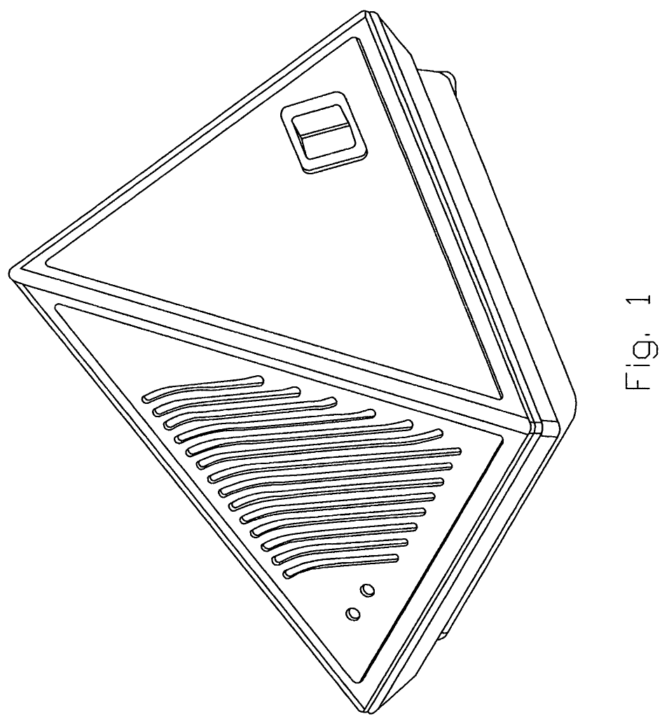

FIG. 2 is the vertical sectional view of the present invention.

FIG. 3 is the horizontal sectional view of the present invention.

FIG. 4 is the structural chart of the present invention.

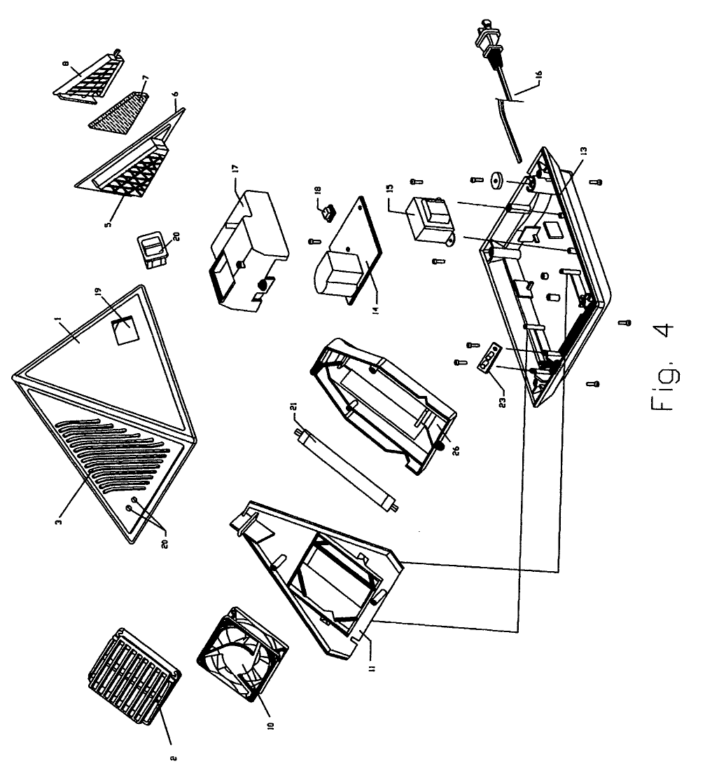

### DETAILED DESCRIPTION OF THE PREFERRED EMBODIMENT

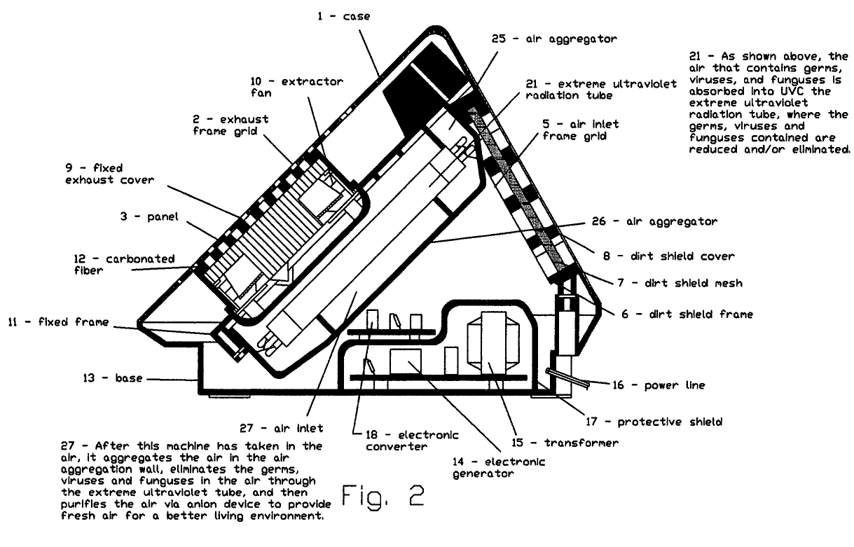

Referring to FIG. 2, said air purifier employs photoelectrons to eliminate germs, viruses, funguses and airborne microorganisms or particles in the air comprising a three-dimensional housing 1, an exhaust frame grid 2 at front end of said housing 1, and a rear end of a panel 3. Ionized air is emitted from said exhaust frame grid 2.

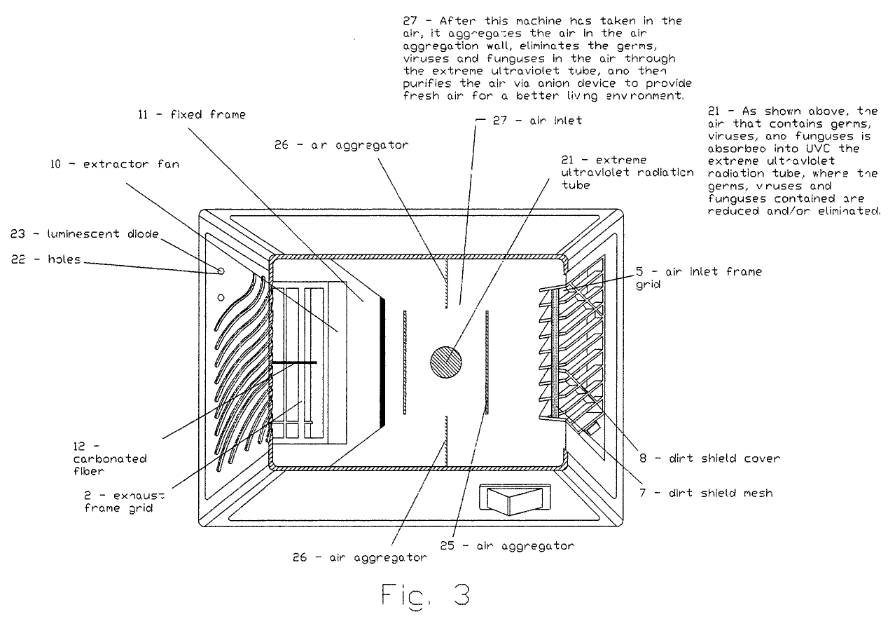

As shown in FIG. 2 and FIG. 3 respectively, said rear end of said housing 1 has an air inlet 5, provides entrance for air. There is a dirt shield frame 6, a dirt shield mesh 7, and a dirt shield cover 8. At the inner surface of said exhaust frame grid 2, there is an extractor fan (fixed) cover 9, an extractor 10, and a fixed frame 11. A carbonated fiber 12 is fixed to a front center of said exhaust frame grid 2. It ionizes said air under high negative voltage.

A base 13 provides a place to affix a power electronic generator 14, a transformer 15, and a power line 16. At an upper portion of said base 13, there is a protective shield 17 for connection and protection, over which shield there is an electronic converter 18. Said protective shield 17 protects the power electronic generator 14 as well as prevent shocking and outflow of high voltage.

In side housing 1, there is a rectangular hole 19 affix to switch 20. Said switch 20 controls said extractor fan 10, said ultraviolet radiation tube 21 and said carbonated fiber 12. In said front of said housing 1, there are two holes 22 to indicate the different colors of luminescent diodes 23.

Said extractor fan 10 intakes air that contains germs, viruses, funguses and other harmful airborne microorganisms or particles in the air, which moves into an air aggregator 25 in said housing 1 through said dirt shield mesh 7. Said air may travel through said air aggregator 25 to reach said exhaust frame grid 2. Said ultraviolet radiation tube 21 is assembled in the center of said air aggregator 25. In other words, when said air full of germs, viruses, funguses and other harmful airborne microorganisms or particles in the air moved into an air aggregation wall 26 through said air aggregator 25, and then into said air inlet 7, which is between said ultraviolet radiation tube 21 and said air aggregation wall 26. When said air full of germs, viruses, funguses and other harmful airborne microorganisms or particles in the air, said ultraviolet radiation tube 21 generates extreme ultraviolet to eliminate said germs, viruses, funguses and other harmful airborne microorganisms or particles in the air. Then purified air is emitted to said exhaust frame grid 2, to further ionized and purified through said high negative voltage carbonated fiber 12. From said exhaust frame grid 2, fresh air filled with anions is emitted to improve the room air.

There is a fence 4 at both front and back portions of said air aggregator 25. Said fence 4 keeps said ultraviolet radiation from emitting beyond said housing 1, thus protects the eyes of the end-user.

Said air purifier works under circuit theory, i.e. after power is input, a high negative voltage circuit is generated through said switch 20, and provides negative voltage output. Said input power also runs through a full-wave rectification circuit to provide power to said extractor fan 10 through a speed-control circuit. One of the power branch runs through DC circuit and AC circuit to activate said ultraviolet radiation tube 21 full-wave rectification circuits. The other branch runs through DC constant voltage circuit to supply an automatic loop-control circuit of anions generating circuit/said ultraviolet radiation tube 21, supporting the alternative operations of a anion generators and said ultraviolet radiation tube 21.

Said anions generated from said anion generator advance biochemical functions (increase the quantity of anions inhaled), and reduce the hormone secretion that causes depressions and fatigues.

Said air purifier generates extreme ultraviolet radiation at 253.7 nanometers of wavelength through said ultraviolet radiation tube 21. Such radiation can eliminate the germs, viruses, funguses and other harmful airborne microorganisms or particles in the air. In modern society, AC device has become an essential facility for the majority of residential houses, hospitals, seniors' homes, malls, cinemas, restaurants, offices, workshops, elevators, cars, steamers, planes and trains. Said air purifier to improves the quality of people's daily life, residential conditions, medical therapy, office work, consumption and transport/communications, etc., and regain a purified space for human being in the modern society where the natural environment continues to be damaged

What is claimed is:

1. An air purifier, comprising:
a three-dimensional housing for actuating an assemblage having a plurality of air inlets and a plurality of air outlets with predetermined sharp, wherein the three-dimensional housing comprises:
at least one extractor fan mean horizontally inserted and engaged in said three-dimensional housing for mean of drawing air into said three-dimensional housing through said air inlet, through a ultraviolet radiation tube mean and out of said housing through said air outlet,
an air aggregator integrally provided between said extractor fan mean and said housing,
a ultraviolet radiation tube mean for generating ultraviolet rays to produce and increase the quantity of anions is integrally connected within said housing, said air inlet and air outlet are connected at both ends of said a ultraviolet radiation tube mean,
an electric circuit with a voltage transformer connected with an indicator light, a starter electrically connected via said electric circuit to said ultraviolet radiation tube,
a switch on said housing electrically connected via said electric circuit between said housing and said air drawing means, and a plug on an electric cord electrically connected to said electric circuit to engage with a wall socket to receive electricity therefrom;
a high negative voltage discharge/carbonated fiber is connected between said ultraviolet radiation tube and said air outlet.

2. An electronic circuit system comprising:
an anion generating circuit, and
an ultraviolet radiation tube generating 253.7 nm start-up circuit.

3. As recited in claim 2, said electronic circuit system is characterized by a high negative voltage output volume as stated, i.e. within the range of 4.5 kv and 8.5 kv.

4. As recited in claim 2, said electronic circuit system is characterized by a variable resistor functions of said anion generating circuit, i.e. to adjust high negative voltage output volume.

5. As recited in claim 2, said electronic circuit system is characterized by a variable resistor functions of said ultraviolet radiation tube generating 253.7 nm start-up circuit, i.e. to adjust high negative voltage output volume.

6. As recited in claim 2, said electronic circuit system is characterized by the fact that said air purifier works in two alternate modes in loop. Said two alternate modes in loops further comprises of:
first mode is to output high negative voltage intermittently (about 3 to 4 minutes between each interception) via said carbonated fiber discharge, said anions produced is then blown out through said extractor fan
second mode is to ignite the extreme ultraviolet radiation intermittently (about 7 to 10 minutes between each interception) to eliminate the germs, viruses, funguses and other harmful airborne microorganisms or particles in the air. User may operate independently and continuously in mode 1 and/or mode 2.

7. As recited in claim 1, there are fences at both front and rear portions of said air aggregator. Said fences keep said extreme ultraviolet radiations from radiating beyond said housing 1, so as to protect the eyes of the user.
